(19) United States
(12) Patent Application Publication
(10) Pub. No.: US 2019/0197011 A1
(43) Pub. Date: Jun. 27, 2019

(54) NETWORK-BASED MACHINE LEARNING MODEL DISCOVERY AND BENCHMARKING

(71) Applicant: AT&T Intellectual Property I, L.P., Atlanta, GA (US)

(72) Inventors: Eric Zavesky, Austin, TX (US); Bernard S. Renger, New Providence, NJ (US); Behzad Shahraray, Holmdel, NJ (US); Tan Xu, Bridgewater, NJ (US); David Crawford Gibbon, Lincroft, NJ (US); Raghuraman Gopalan, Dublin, CA (US)

(21) Appl. No.: 15/852,373

(22) Filed: Dec. 22, 2017

(51) Int. Cl. G06F 15/18; G06F 11/34; G06F 17/30; G06K 9/62

(52) U.S. Cl. CPC G06F 15/18; G06K 9/6217; G06F 17/3053; G06F 11/3428

(57) ABSTRACT

A method may include a processing system having at least one processor receiving a data processing task from a user device, determining a plurality of sub-tasks of the data processing task, determining a plurality of machine learning models for performing the plurality of sub-tasks, and arranging the plurality of machine learning models into a plurality of candidate solutions for performing the data processing task. The processing system may further evaluate the plurality of candidate solutions using a test data set to provide measures of a plurality of performance metrics for each of the plurality of candidate solutions, and provide a solution comprising one of the plurality of candidate solutions to the user device, where the solution is selected based upon the measures of the plurality of performance metrics.

The present disclosure relates generally to machine learning models, and more particularly to providing a solution comprising a set of machine learning models for performing a data processing task.

### BACKGROUND

At the core of big data applications and services are machine learning models that analyze large volumes of data to deliver various insights, key performance indicators, and other actionable information to the users of the applications and services. Designers may differentiate machine learning models, or machine learning algorithms (MLAs) for different big data applications involving video, speech, text, location information, images, network traffic data, and so forth. For example, different machine learning models (derived from corresponding MLAs) may include support vector machine (SVMs), e.g., binary classifiers and/or linear binary classifiers, multi-class classifiers, kernel-based SVMs, or the like, a distance-based classifier, a decision tree algorithm/model, a k-nearest neighbor (KNN) algorithm/model, and so on.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication service provider network, according to the present disclosure;

FIG. 2 illustrates an example flowchart of a method for providing a solution comprising a set of machine learning models for performing a data processing task; and

FIG. 3 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses devices, non-transitory (i.e., tangible or physical) computer-readable storage media, and methods for providing a solution comprising a set of machine learning models for performing a data processing task. For instance, in one example, a processing system including at least one processor may receive a data processing task from a user device, determine a plurality of sub-tasks of the data processing task, determine a plurality of machine learning models for performing the plurality of sub-tasks, and arrange the plurality of machine learning models into a plurality of candidate solutions for performing the data processing task. The processing system may further evaluate the plurality of candidate solutions using a test data set to provide measures of a plurality of performance metrics for each of the plurality of candidate solutions, and provide a solution comprising one of the plurality of candidate solutions to the user device, where the solution is selected based upon the measures of the plurality of performance metrics.

At the core of big data applications and services are machine learning models that analyze large volumes of data to deliver various insights, key performance indicators, and other actionable information to the users of the applications and services. Designers may differentiate machine learning models, or machine learning algorithms (MLAs) for different big data applications involving video, speech, text, location information, images, network traffic data, and so forth. As referred to herein, a machine learning model may comprise a MLA that has been “trained” or configured in accordance with input data (e.g., training data) to perform a particular service. Examples of the present disclosure are not limited to any particular type of MLA/model, but are broadly applicable to various types of MLAs/models that utilize training data, such as support vector machines (SVMs), e.g., linear or non-linear binary classifiers, multi-class classifiers, deep learning algorithms/models, decision tree algorithms/models, k-nearest neighbor (KNN) clustering algorithms/models, and so forth.

Machine learning systems are increasingly being used to perform various data processing tasks, such as facial recognition, character recognition, object recognition, route planning, package sorting, precision control systems, autonomous navigation, dynamic pricing, automated securities and commodities trading, and so on. Many of the components (e.g., MLAs and/or MLMs) are reusable across a variety of data processing tasks for the same or similar applications, or for entirely different applications. Examples of the present disclosure provide a network-based platform where vendors may upload and offer their MLAs and/or MLMs for purchase, lease, or license, and where users may browse and select MLAs and/or MLMs for their data processing tasks.

In one example, the network-based platform may assign MLAs and/or MLMs to one or more function categories, or categories of use. For instance, a first MLM may comprise a model trained via multi-class learning for facial recognition. A second MLM may comprise a decision tree-based facial recognition model. Both of these models may be associated with a function category of “facial recognition.” The assignment of MLMs to categories may be automatically made by the network-based platform, or may be selected by a vendor that uploads the MLM to the network-based platform.

In one example, the network-based platform also maintains a number of objective measures of performance metrics for MLAs and/or MLMs. For instance, the network-based platform may store measures of performance metrics such as runtime, consistency of performance, usage, class of service (uptime, updates), accuracy, availability off-line, and reputation of vendor. In one example, where an MLM and/or MLM is assigned to more than one function category, the network-based platform may maintain different measures of performance metrics in connection with the different function categories. In one example, the measures of performance metrics may be based upon the network-based platform applying test data sets to the MLAs and/or MLMs and capturing measurements for various performance metrics. For instance, certain data sets are available for benchmarking video encoding models, other data sets are available for benchmarking image salience detection models, still other data sets are available for benchmarking facial recognition models, and so on. In one example, these metrics may also be updated with each use of a MLA and/or MLM via the network-based platform. Thus, the measures may be statically computed on standard data sets as well as continuously updated through model usage (e.g., where the usage is executed on the network-based platform).

In one example, the network-based platform may assist a user in assembling a solution involving multiple MLMs to perform a particular data processing task. In particular, in accordance with the present disclosure a data processing task may be broken down into component tasks, or sub-tasks, where each sub-task may be performed by a component MLM. In one example, solution discovery may involve both user-driven and automated evaluation of criteria to pick a “best” solution. For instance, for a novice, the network-based platform may select all component MLMs for a data processing task. For an intermediate or advanced user, the user may apply weights to important selection criteria, e.g., runtime, accuracy, etc., which may then be evaluated by the network-based platform to select component MLMs, or may apply absolute requirements, such as no less accurate than “X” or no longer runtime than “Y” seconds. Alternatively, or in addition, the user may customize (pick and choose) specific component MLMs to arrange in a solution. In one example, the network-based platform may detect that there is an insufficient number of candidate MLMs with regard to one or more sub-tasks to choose from. In such an example, the network-based platform may notify vendors who have uploaded MLMs in a same area or in one or more related areas of a deficiency and an opportunity to meet a current demand.

To illustrate, a user may have a data processing task of facial recognition from images captured via security camera at a facility access door. The task may generally involve receiving an image, extracting features from the image, and then applying the features to a facial recognition model. The task may be broken down in several ways. For example, a solution may involve first detecting parts of a face, such as eyes, nose, mouth, etc. as part of a feature extraction process. In one example, different MLMs may be utilized to perform these initial steps. Thereafter, features may be extracted such as a length of a nose, eye color, etc. which may then comprise inputs to a classification stage. The classification stage could comprise a decision tree with some leaves representing different known individuals who are permitted entry, other leaves for known individuals who are not permitted entry and/or for unknown individuals (who may initially be restricted from entry until personally escorted into the facility), and so forth. However, in another example, the classification stage could comprise a k-nearest neighbor (KNN) classification model, a series of binary classifiers/SVMs (e.g., one per known individual), and so forth.

In one example, the user may have a preference that certain MLMs or a certain type of MLM be used as part of the solution. Thus, the user may specify certain MLMs or types of MLMs be utilized for certain sub-tasks. For instance, if the user is only interested in whether or not an image contains one of five object types, the user may prefer to utilize five binary classifiers for an object recognition model, rather than a decision tree which may be trained to detect and distinguish between 100 object types (including the five object types of interest), but which may do so with less accuracy. However, another use may have a similar data processing task, but may be inexperienced or unfamiliar with available component models. The user may specify that the data processing task is for object recognition and may indicate that each image should be processed in no longer than “X” milliseconds and that a classification accuracy should be greater than “Y” percent. The network-based platform may then search for one or more solutions that meet these criteria.

In one example, the network-based platform may select one or more known arrangements of a plurality of sub-tasks as a template for the data processing task. For instance, a known arrangement may exist for a previous work where sub-tasks were manually arranged by a data scientist for performance of a similar task, where similarity may be determined by the processing system in a number of ways. For instance, a user may previously have arranged a solution for a data processing task of detecting images of lions. Another user may subsequently engage the network-based platform with a data processing task of detecting images of tigers. The network-based platform may associate the new data processing task with the previously completed data processing task based upon an association of the concept of “tiger” with the concept of “lion” and the fact that both the previous task and the new task are for performing recognition from a set of still images.

In another example, a user may engage the network-based platform for a data processing task of identifying and classifying the sounds of large cats from a set of audio recordings (e.g., detecting and distinguishing the sounds of lions from tigers, and so forth). The network-based platform may have stored therein a solution for a previous data processing task of identifying and classifying different bird calls. Thus, the network-based platform may search the records and select this solution as a template for an arrangement of sub-tasks for the new data processing task relating to the large cat sounds. However, if a record of such a previous solution does not exist, the network-based platform may consider a different previous solution as a template which may have less correspondence to the currently proposed task. For instance, a previous solution may be stored for a task of distinguishing different speakers at a telephone conference. The network-based platform may search for and find this previous solution, and use this previous solution as a template for the task of identifying and classifying the large cat sounds. In general, as more data processing tasks are arranged via the network-based platform, the choices of templates for various data processing tasks may grow in relevance and specificity. In one example, the network-based platform may detect that there is an insufficient number of previous solutions to provide useful templates. In such an example, the network-based platform may notify vendors who have uploaded MLMs in a same area or in one or more related areas of a deficiency and of an opportunity to meet a current demand.

In one example, the network-based platform may provide a recommendation of the arrangement of sub-tasks to the device and receive an acceptance of the arrangement of sub-tasks, a change in one or more of the sub-tasks, and/or a reorganizing of the sub-tasks from the user. For example, an intermediate user may provide one or more selection criteria to the network-based platform, but leave it to the network-based platform to arrange for proposed solutions. However, upon seeing the proposed arrangement of sub-tasks, the user may be knowledgeable enough to know that he or she prefers a different arrangement, to know that the proposed arrangement will not work, or may not work well for the intended purpose, and so forth. Thus, the user may prefer to alter the arrangement of sub-tasks as compared to the template that is selected by the network-based platform.

In one example, the network-based platform may maintain a database matching available MLMs with associated functions, where the associated functions may be mapped to the plurality of sub-tasks. For instance, as stated above, a sub-task for “facial classification” could alternatively comprise a decision tree, a k-nearest neighbor (KNN) classification model, a series of binary classifiers/SVMs (e.g., one per known individual), and so forth. Thus, a function category of “facial classification” may list one or more decision tree-based MLMs, one or more KNN-based MLMs, and so forth.

In one example, the network-based platform may select different component MLMs for various sub-tasks to come up with different candidate solutions for an overall data processing task. For instance, the network-based platform may generate different candidate solutions comprising different combinations of component MLMs for respective sub-tasks. In one example, the MLMs that may be selected for possible assignment to a sub-task may be pre-screened for compliance with various criteria. For instance, a user may specify a maximum cost per-MLM/cost per-sub-task, a maximum runtime, a maximum network latency, and so forth with respect to each sub-task, or for the sub-tasks in general. Other criteria may include user-defined requirements regarding an availability for local execution, an availability for network-based execution, an availability for retraining, an availability of source code for inspection, an availability of a third-party verification, a system compatibility, a geographic availability, and so on. Thus, any MLM that does not meet these criteria may be excluded from consideration.

In one example, the database matching MLMs to function categories includes a ranking of MLMs for each function category. In one example, the ranking may be based upon measures of one or more performance metrics, as described in greater detail below. In one example, the network-based platform may only select MLMs having a ranking above a certain threshold as possibilities for various tasks when formulating a set of candidate solutions. Once different combinations of MLMs are mixed and matched to generate candidate solutions, the network-based platform may then evaluate the candidate solutions to select a “best,” or several “best” proposed solutions to recommend to a user.

In one example, the evaluation may comprise calculating measures of sub-task performance metrics for each of the MLMs of a candidate solution, and aggregating the measures of sub-task performance metrics to provide a set of performance metrics for the overall candidate solution. The plurality of performance metrics may include, for example: a runtime, a processor utilization, a memory utilization, a training time, an accuracy, a latency (e.g., for network-based execution of the solution), and so forth. The plurality of performance metrics may also include features that may alternatively or additionally be used to pre-screen MLMs, such as a cost, an availability for local execution and/or network-based execution, an availability for retraining, an availability of source code inspection and/or independent third-party verification, a system compatibility, a geographic availability, an ability to utilize without divulging the data set in question, a factor relating to whether the MLMs in a candidate solution are from a single vendor or from multiple vendors, and so on.

In one example, the plurality of performance metrics is provided by a user. For instance, the rankings as maintained in the database utilized by the network-based platform may be set up with respect to one or more criteria selected by the operator of the network-based platform, based upon a popularity of certain performance metrics as defined by other users, and so forth. However, the current user may have different criteria of importance. For example, for the same or similar tasks, but for different users, one user may be most interested in a classification accuracy whereas another user may be most interested in a classification speed and is more willing to tolerate a lower classification accuracy. Thus, the overall scoring of a proposed solution may vary from user to user even for the same task or substantially similar tasks.

It should be noted that some of the measures of performance metrics noted above may call for the application of an MLM to one or more test data sets. For example, certain data sets are available for benchmarking video encoding models, other data sets are available for benchmarking image salience detection models, still other data sets are available for benchmarking facial recognition models, and so on. Thus, in one example, the sub-task performance metrics may be generated with respect to these standard data sets. However, in accordance with the present disclosure, MLMs for sub-tasks of the plurality of candidate solutions, and/or the overall candidate solutions may be evaluated with respect to a test data set provided by the user. For instance, if the data processing task is facial recognition from images captured via a security camera at a facility access door, the network-based platform may have measure of performance metrics of different possible component MLMs regarding several standard image datasets. However, this may not include the images captured via the particular type of camera that will be in use at the facility access door. Thus, the user may have sample images obtained via the facility access door that can be applied to different possible component MLMs and/or the overall candidate solutions to provide benchmark measures of a plurality of performance indicators. Notably, different MLMs or candidate solutions may end up with different ratings or rankings with respect to the user-defined criteria and with regard to the user's specific data set. In other words, some MLMs may provide a better performance on the standard test data sets, while other MLMs may have a better performance with respect to the user-supplied test data and the user-defined criteria.

In one example, the user may upload the test data to the network-based platform. In another example, the user may direct the network-based platform to another network-based repository where the test data can be accessed (e.g., via a uniform resource locator (URL)). In addition, in one example, the network-based platform may update the rankings of various MLMs based upon measures of sub-task performance metrics based upon the user-supplied test data. Thus, in one example, MLMs that perform best over a wide variety of input test data sets may be ranked higher than those that simply perform the best over standard test/training data sets. In one example, the network based platform may also send a notification to a vendor to retrain one of the plurality of MLMs when the MLM falls in at least one of the rankings or has a measure of at least one of the plurality of performance indicators fall below a threshold amount or percentage change in performance. Notably, some vendors may train their MLMs with proprietary data sets prior to offering the MLMs for purchase, lease, license, etc. and may not allow users to retrain the MLM. Thus, the vendor may retrain the MLM, e.g., using a broader training data set, if the vendor so chooses to attempt to increase the performance (and/or the rating) of the MLM. In one example, the vendor may continue to offer the previous version of the MLM, and may offer a different version of the MLM that may be trained with a different training data set, and which may therefore have a different level of performance with respect to a user-provided test data set.

In one example, the network-based platform may offer one or more of the candidate solutions as a recommended solution for possible selection by the user. In one example, the recommended solution(s) may be presented with an overall score/ranking, a listing of measures of one or more performance indicators, a total cost, and various other aspects of information, such as restrictions on where the proposed solution may be executed (e.g., restricted to execution on the network-based platform or available for download and location execution, an availability within certain countries or regions, and so forth). Thus, examples of the present disclosure provide for solution discovery and side-by-side comparison using a sample data set from a prospective user and with respect to one or more user-defined criteria.

In various examples, the network-based platform may offer various additional options, such as differential pricing between in-network and local execution, differential pricing for access to the underlying MLA and the ability to retrain an MLM with additional training data provided by the user, and so forth. In one example, the network-based platform may receive a selection of a proposed solution from the user and may then either apply the solution to a new dataset (e.g., via the network-based platform) or may provide the component MLMs of the selected solution to a device of the user. In the first example, the new data set may be provided to the network-based platform by the user, or the user may direct the network-based platform where to obtain the new data set from a network-based repository or data streaming source (e.g., via a URL).

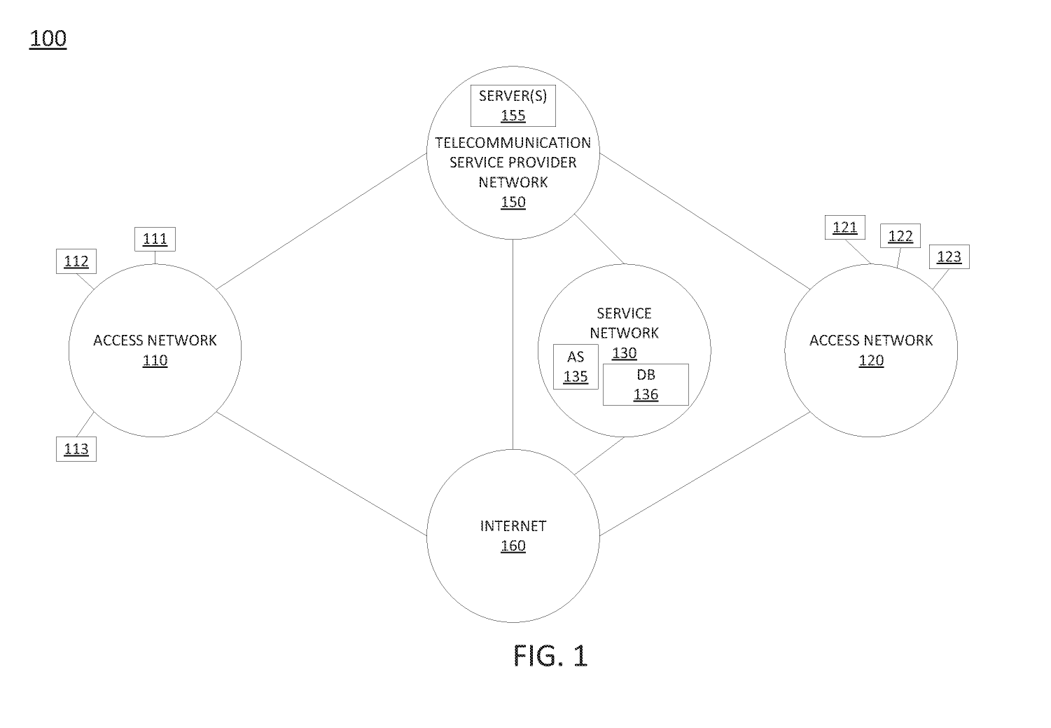

In one example, the network-based platform may provide for enhanced performance of a data processing task by introducing various degrees of parallelism in executing a solution. For instance, the network-based platform may provide various measures of performance metrics when providing one or more proposed solutions. However, the network-based platform may also introduce estimates of performance enhancement if the solution were to exploit aspects of parallelism, such as using a MapReduce operation to distribute an input data stream to a number of clusters (e.g., processing system). In one example, the parallelism may be introduced as part of creating a solution template. In other words, the parallelism is part of the template. In another example, the parallelism may be generated by the network-based platform once a candidate solution is accepted. In still another example, the network-based platform may suggest various extract, transform, and/or load (ETL) operations as data pre-processing steps which may increase the performance of the solution. For instance, the ETL recommendation(s) such as certain types of features extraction, feature reduction, dimensionality reduction, and so forth may be provided by one or more of the MLM vendors, by other users who have previously used the MLMs as components of a solution for another data processing task, and so forth. These and other aspects of the present disclosure are discussed in greater detail below in connection with the examples of FIGS. 1-3.

To aid in understanding the present disclosure, FIG. 1 illustrates an example system 100 comprising a plurality of different networks in which examples of the present disclosure for providing a solution comprising a set of machine learning models for performing a data processing task may operate.

Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

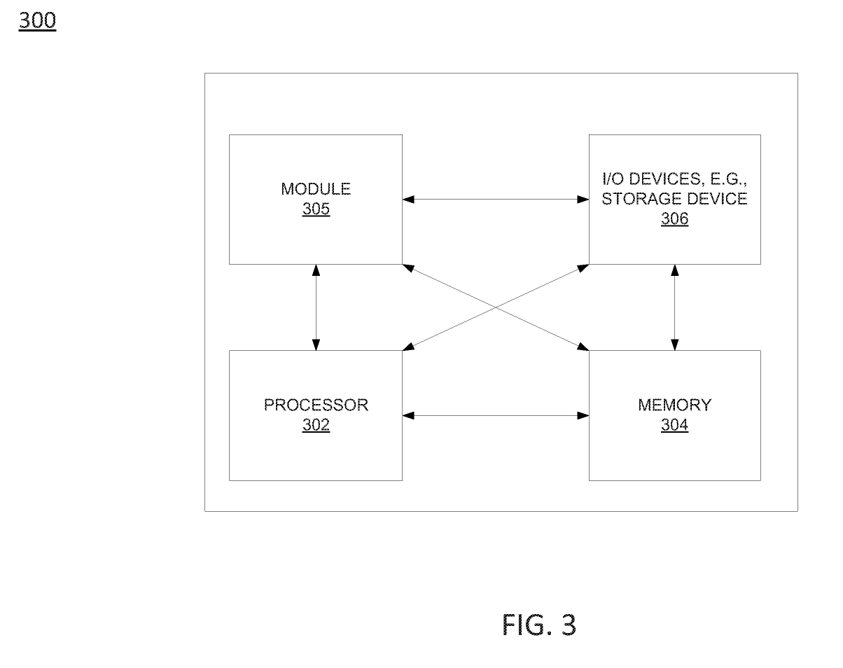

In one example, telecommunication service provider network 150 may also include one or more servers 155. In one example, the servers 155 may each comprise a computing system, such as computing system 300 depicted in FIG. 3, and may be configured to host one or more centralized system components in accordance with the present disclosure. For example, a first centralized system component may comprise a database of assigned telephone numbers, a second centralized system component may comprise a database of basic customer account information for all or a portion of the customers/subscribers of the telecommunication service provider network 150, a third centralized system component may comprise a cellular network service home location register (HLR), e.g., with current serving base station information of various subscribers, and so forth. Other centralized system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. Other centralized system components may include, for example, a layer 3 router, a short message service (SMS) server, a voicemail server, a video-on-demand server, a server for network traffic analysis, and so forth. It should be noted that in one example, a centralized system component may be hosted on a single server, while in another example, a centralized system component may be hosted on multiple servers, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113 and 121-123, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide mobile core network 130 functions, e.g., of a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and or users. For example, telecommunication service provider network 150 may provide a cloud storage service, web server hosting, and other services. As such, service network 130 may represent aspects of telecommunication service provider network 150 where infrastructure for supporting such services may be deployed. In another example, service network 130 may represent a third-party network, e.g., a network of an entity that provides a service for providing a solution comprising a set of machine learning models for performing a data processing task, in accordance with the present disclosure.

In the example of FIG. 1, service network 130 may include an application server (AS) 135. In one example, AS 135 may comprise all or a portion of a computing device or system, such as computing system 300, and/or processing system 302 as described in connection with FIG. 3 below, specifically configured to perform various steps, functions, and/or operations for providing a solution comprising a set of machine learning models for performing a data processing task. For instance, AS 135 may comprise a network-based platform for providing a solution comprising a set of machine learning models for performing a data processing task, as described above. In one example, service network 130 may also include a database (DB) 136, e.g., a physical storage device integrated with AS 135 (e.g., a database server), or attached or coupled to the AS 135, to store various types of information in support of systems for providing a solution comprising a set of machine learning models for performing a data processing task, in accordance with the present disclosure. For instance, DB 136 may store various MLMs, training and/or testing data for the various MLMs, lists of function categories and associated MLMs, MLM performance parameters, templates and/or previous solutions for various data processing tasks, and so forth. In one example, AS 135 and/or DB 136 may comprise cloud-based and/or distributed data storage and/or processing systems comprising one or more servers at a same location or at different locations. However, for ease of illustration, these components are depicted as standalone devices in FIG. 1.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

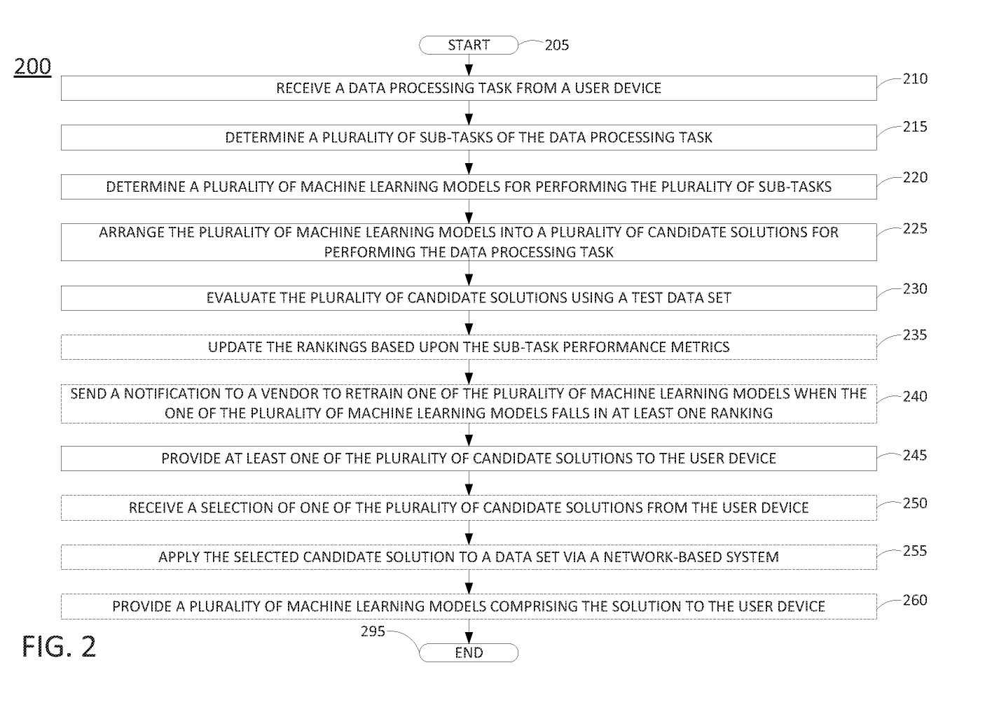

In one example, any one or more of user devices 111-113 and/or user devices 121-123 may comprise vendor devices for uploading and offering MLM (and or underlying MLA) for purchase, lease, download, licensing, etc. via AS 135. In addition, any one or more of user devices 111-113 and/or user devices 121-123 may comprise user devices for obtaining solutions to data processing tasks from AS 135. In this regard, AS 135 may maintain communications one or more of user devices 111-113 and/or user devices 121-123 via access networks 110 and 120, telecommunication service provider network 140, Internet 160, and so forth. Various additional functions of AS 135 in connection with providing a solution comprising a set of machine learning models for performing a data processing task are described in greater detail below in connection with the example of FIG. 2.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, after a user accepts a solution, a data processing task may be executed via a cluster controlled by the user or by service network 130. Thus, the network 100 may include a cluster comprising multiple computing devices in access networks 110 and/or 120, in service network 130, in another service network connected to Internet 160 (e.g., a cloud computing provider), and so forth. Thus, these and other modifications are all contemplated within the scope of the present disclosure.

FIG. 2 illustrates an example flowchart of a method 200 for providing a solution comprising a set of machine learning models for performing a data processing task. In one example, steps, functions and/or operations of the method 200 may be performed by a device as illustrated in FIG. 1, e.g., application server 135. Alternatively, or in addition, the steps, functions and/or operations of the method 200 may be performed by a processing system collectively comprising a plurality of devices as illustrated in FIG. 1, such as application server 135, DB 146, endpoint devices 111-113 and/or 121-123, and so forth. In one example, the steps, functions, or operations of method 200 may be performed by a computing device or system 300, and/or a processing system 302 as described in connection with FIG. 3 below. For instance, the computing device 300 may represent at least a portion of a server, an application server, an endpoint device, and so forth, in accordance with the present disclosure. For illustrative purposes, the method 200 is described in greater detail below in connection with an example performed by a processing system, such as processing system 302. The method 200 begins in step 205 and proceeds to step 210.

At step 210, the processing system receives a data processing task from a user device.

At step 215, the processing system determines a plurality of sub-tasks of the data processing task. In one example, the sub-tasks are selected based upon at least one of an instruction from the user device. In addition, in one example, an arrangement of the subtasks is selected based upon the instruction from the user device. In another example, the sub-tasks are selected based upon a known arrangement of sub-tasks for the data processing task. For instance, a known arrangement may exist for a previous work where sub-tasks were manually arranged by a data scientist for performance of a similar task, where similarity may be determined by the processing system in a number of ways, such as a same type of operations, a same or a similar subject matter, and so forth. In one example, step 215 may include providing a recommendation of the plurality of sub-tasks to the user device and receiving a selection of the plurality of sub-tasks from the user device. For instance, if the user is only interested in whether or not an image contains one of five object types, the user may prefer to utilize five binary classifiers for an object recognition model, rather than a decision tree which may be trained to detect and distinguish between 100 object types as may be initially selected by the processing system.

At step 220, the processing system determines a plurality of machine learning models for performing the plurality of sub-tasks. In one example, step 220 is based upon a database of MLMs and associated functions, wherein the associated functions are mapped to the plurality of sub-tasks. For instance, at step 220, the processing system may perform a lookup in the database using the types of sub-tasks that are determined at step 215. In one example, step 220 may further include screening the plurality of machine learning models for compliance with at least one of: a cost, an availability for local execution, an availability for network-based execution, an availability for retraining, an availability of source code for inspection, an availability of a third-party verification, a system compatibility, a geographic availability, and so forth. In one example, the plurality of machine learning models is uploaded to the database by a plurality of different vendors. In one example, the database of machine learning models includes a ranking of machine learning models for each of a plurality of functions. In such an example, the ranking may be based upon measures of at least one of the performance metrics for at least one general test data set. In one example, the processing system may select MLMs having a ranking above a certain threshold as possibilities for various sub-tasks.

At step 225, the processing system arranges the plurality of machine learning models into a plurality of candidate solutions for performing the data processing task. In one example, the plurality of candidate solutions comprises a plurality of combinations of the plurality of machine learning models. For example, different combinations of MLMs are mixed and matched to generate candidate solutions (where each MLM may be assigned to a respective sub-task having a function that is associated with the MLM). In one example, candidate solutions may be created with all possible combinations of MLM for different sub-tasks. In another example, the processing system may stop when a certain number of candidate solutions is generated, e.g., five, ten, etc.

At step 230, the processing system evaluates the plurality of candidate solutions using a test data set to provide measures of a plurality of performance metrics for each of the plurality of candidate solutions. In one example, the test data set is provided by the user device either directly or by the user device referring the processing system to a network-based repository to obtain the test data set. In one example, the plurality of performance metrics is provided by the user device. In one example, step 230 includes calculating measures of sub-task performance metrics for each of the plurality of machine learning models for a respective one of the plurality of sub-tasks. In one example, step 230 further includes calculating the measures of the plurality of performance metrics for each of the plurality of candidate solutions based upon the measures of sub-task performance metrics (where each solution comprises at least two of the plurality of machine learning models). For instance, the processing system may aggregate the measures of sub-task performance metrics to provide a set of performance metrics for the overall candidate solution. The plurality of performance metrics may include, for example: a runtime, a processor utilization, a memory utilization, a training time, an accuracy, a latency (e.g., for network-based execution of the solution), and so forth. The plurality of performance metrics may also include features that may alternatively or additionally be used to pre-screen MLMs, such as a cost, an availability for local execution and/or network-based execution, an availability for retraining, an availability of source code inspection and/or independent third-party verification, a system compatibility, a geographic availability, an ability to utilize without divulging the data set in question, a factor relating to whether the MLMs in a candidate solution are from a single vendor or from multiple vendors, and so on.

At optional step 235, the processing system may update rankings of the MLMs based upon the sub-task performance metrics. For instance, MLMs that perform best over a wide variety of input test data sets may be ranked higher than those that simply perform the best over standard test/training data sets.

At optional step 240, the processing system may send a notification to a vendor to retrain one of the plurality of MLMs when the one of the plurality of MLMs falls in at least one of the rankings. For example, some vendors may train their MLMs with proprietary data sets prior to offering the MLMs for purchase, lease, license, etc. and may not allow users to retrain the MLM. Thus, the vendor may retrain the MLM, e.g., using a broader training data set, if the vendor so chooses to attempt to increase the performance (and/or the rating) of the MLM as compared to other MLMs of the same function category.

At step 245, the processing system provides a solution comprising one of the plurality of candidate solutions to the user device. In one example, the processing system selects the solution based upon the measures of the plurality of performance metrics. In one example, step 245 may comprise presenting one or more of the top ranked candidate solutions based upon the aggregate performance metrics. In one example, the processing system may rank the candidate solutions using a weighted function of the measures of the performance metrics. In one example, the weightings of different performance metrics may be selected by the user, or may be set to default values for the processing system which may be selectively updated by the user. In one example, a cost and other terms or options, such as a license duration, or a choice of license durations, any geographic restrictions, system requirements, and so forth may be provided along with the solution.

At optional step 250, the processing system may receive a selection of the solution from the user device. For instance, the user may evaluate the cost and other terms or options associated with the solution to determine whether or not to accept the solution. In one example, the user may compare the solution to other candidate solutions to make a choice. The acceptance of the solution may be sent from the user device and received by the processing system at optional step 250. In one example, at optional step 250, the processing system may also receive a selection of one or more options associated with the solution, such as whether the data processing task is to be executed in-network or locally.

At optional step 255, the processing system may apply the solution to a data set via a network-based system. For instance, if the user has selected for network-based performance of the data processing task, the solution may be implemented in-network, e.g., at the processing system, or via another processing system as directed by the processing system performing the method 200.

At optional step 260, the processing system may provide a plurality of MLMs comprising the solution to the user device. For instance, if the user has selected for local performance of the data processing task, the processing system may provide the solution (e.g., including the component MLMs) to the user device. In one example, the solution may be implemented at the user device. In another example, the solution may be performed via another processing system as directed by the user device.

Following step 245, or any of optional steps 250-260, the method 200 ends. It should be noted that the method 200 may be expanded to include additional steps or may be modified to include additional operations with respect to the steps outlined above. For instance, the processing system may assist a user or vendor in retraining an MLM, evaluate whether improved performance may be obtained from a retrained MLM for a given task, and so forth. In another example, the processing system may make recommendations to the user regarding data transformation steps that can or should be implemented before or in conjunction with one or more sub-task, or in connection with a particular MLM. In still another example, the processing system may notify vendors when there is an insufficient number of prior solutions from which to obtain a template for arranging the plurality of sub-tasks (e.g., in connection with step 215) when there is an insufficient number of MLMs to choose from (e.g., in connection with step 220), and so forth. Thus, these and other modifications are all contemplated within the scope of the present disclosure.

In addition, although not specifically specified, one or more steps, functions or operations of the method 200 may include a storing, displaying and/or outputting step as required for a particular application. In other words, any data, records, fields, and/or intermediate results discussed in the method 200 can be stored, displayed and/or outputted either on the device executing the method 200, or to another device, as required for a particular application. Furthermore, steps, blocks, functions, or operations in FIG. 2 that recite a determining operation or involve a decision do not necessarily require that both branches of the determining operation be practiced. In other words, one of the branches of the determining operation can be deemed as an optional step. In addition, one or more steps, blocks, functions, or operations of the above described method 200 may comprise optional steps, or can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for providing a solution comprising a set of machine learning models for performing a data processing task, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, transceivers, power units, and so forth. Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200, or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for providing a solution comprising a set of machine learning models for performing a data processing task (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for providing a solution comprising a set of machine learning models for performing a data processing task (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor, a data processing task from a user device;
determining, by the processing system, a plurality of sub-tasks of the data processing task;
determining, by the processing system, a plurality of machine learning models for performing the plurality of sub-tasks;
arranging, by the processing system, the plurality of machine learning models into a plurality of candidate solutions, wherein each of the plurality of candidate solutions is capable of performing the data processing task;
evaluating, by the processing system, the plurality of candidate solutions using a test data set, wherein the evaluating provides measures of a plurality of performance metrics for each of the plurality of candidate solutions; and
providing, by the processing system, at least one of the plurality of candidate solutions to the user device, wherein the at least one of the plurality of candidate solutions is selected based upon the measures of the plurality of performance metrics.

2. The method of claim 1, wherein the plurality of candidate solutions comprises a plurality of combinations of the plurality of machine learning models.

3. The method of claim 1, wherein the test data set is provided by the user device.

4. The method of claim 1, wherein the plurality of performance metrics is provided by the user device.

5. The method of claim 1, wherein the evaluating comprises:
calculating measures of sub-task performance metrics for each of the plurality of machine learning models for a respective one of the plurality of sub-tasks.

6. The method of claim 5, wherein the evaluating further comprises:
calculating the measures of the plurality of performance metrics for each of the plurality of candidate solutions based upon the measures of sub-task performance metrics.

7. The method of claim 1, wherein the determining the plurality of sub-tasks of the data processing task is based upon at least one of:
an instruction from the user device; or
a known arrangement of the plurality of sub-tasks for the data processing task.

8. The method of claim 1, wherein the determining the plurality of machine learning models for performing the plurality of sub-tasks is based upon a database of machine learning models and associated functions, wherein the associated functions are mapped to the plurality of sub-tasks.

9. The method of claim 8, wherein the determining the plurality of machine learning models comprises:
screening the plurality of machine learning models for compliance with at least one of:
a cost;
an availability for local execution;
an availability for network-based execution;
an availability for retraining;
an availability of source code for inspection;
an availability of a third-party verification;
a system compatibility; or
a geographic availability.

10. The method of claim 8, wherein the plurality of machine learning models is uploaded to the database by a plurality of different vendors.

11. The method of claim 10, wherein the database of machine learning models includes rankings of machine learning models for each of a plurality of functions, wherein the ranking is based upon the measures of at least one of the performance metrics for at least one general test data set.

12. The method of claim 11, wherein the evaluating the plurality of candidate solutions comprises:
calculating sub-task performance metrics for each of the plurality of machine learning models for a respective one of the plurality of sub-tasks.

13. The method of claim 12, further comprising:
updating the rankings based upon the sub-task performance metrics.

14. The method of claim 13, further comprising:
sending a notification to a vendor to retrain one of the plurality of machine learning models when the one of the plurality of machine learning models falls in at least one of the rankings.

15. The method of claim 1, further comprising:
receiving a selection of the solution from the user device; and
applying the solution to a data set via a network-based system.

16. The method of claim 1, further comprising:
receiving a selection of the solution from the user device; and
providing a plurality of machine learning models comprising the solution to the user device.

17. The method of claim 1, wherein the plurality of performance metrics includes:
a runtime;
a processor utilization;
a memory utilization;
a training time;
an accuracy; or
a latency.

18. The method of claim 1, wherein the determining the plurality of sub-tasks comprises:
providing a recommendation of the plurality of sub-tasks to the user device; and
receiving a selection of the plurality of sub-tasks from the user device.

19. A non-transitory computer-readable storage medium storing instructions which, when executed by a processing system including at least one processor, cause the processing system to perform operations, the operations comprising:
receiving a data processing task from a user device;
determining a plurality of sub-tasks of the data processing task;
determining a plurality of machine learning models for performing the plurality of sub-tasks;
arranging the plurality of machine learning models into a plurality of candidate solutions, wherein each of the plurality of candidate solutions is capable of performing the data processing task;
evaluating the plurality of candidate solutions using a test data set, wherein the evaluating provides measures of a plurality of performance metrics for each of the plurality of candidate solutions; and
providing at least one of the plurality of candidate solutions to the user device, wherein the at least one of the plurality of candidate solutions is selected based upon the measures of the plurality of performance metrics.

20. A device comprising:
a processing system including at least one processor; and
a computer-readable medium storing instructions which, when executed by the processor, cause the processor to perform operations, the operations comprising:
receiving a data processing task from a user device;
determining a plurality of sub-tasks of the data processing task;
determining a plurality of machine learning models for performing the plurality of sub-tasks;
arranging the plurality of machine learning models into a plurality of candidate solutions, wherein each of the plurality of candidate solutions is capable of performing the data processing task;
evaluating the plurality of candidate solutions using a test data set, wherein the evaluating provides measures of a plurality of performance metrics for each of the plurality of candidate solutions; and
providing at least one of the plurality of candidate solutions to the user device, wherein the at least one of the plurality of candidate solutions is selected based upon the measures of the plurality of performance metrics.
